(19) United States
(12) Patent Application Publication
(10) Pub. No.: US 2002/0017575 A1
(43) Pub. Date: Feb. 14, 2002

(54) Spray head

(75) Inventors: Darren Paul Andrews, Wirral (GB); Gregory Alan Erickson, Chicago, IL (US); Euan Stuart Reid, Wirral (GB); Keith Leslie Rutherford, Wirral (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/899,746

(22) Filed: Jul. 5, 2001

(30) Foreign Application Priority Data
Jul. 5, 2000 (GB) 0016558.9
Mar. 14, 2001 (GB) 0106284.3

(51) Int. Cl. B05B 9/043; B05B 7/32; B05B 1/14

(52) U.S. Cl. 239/337; 239/333; 239/548; 239/569; 239/587.1

(57) ABSTRACT

A spray head for delivering a hair care composition onto and/or into the hair comprising an inlet in fluid communication with an outlet, the inlet of the spray head being adapted for connection with an outlet of a container including a hair care composition, the outlet of the spray head including at least one hollow protrusion defining a fluid channel extending from the spray head, the hollow protrusion including an opening for delivering the atomized hair care composition onto the hair.

The present invention relates to apparatus and methods for dispensing a hair care composition, in particular a hairspray, onto the hair.

Hair care compositions, particularly hairsprays, are usually applied directly to the hair during treatment and styling procedures by dispensing the hair care composition from a container such as an aerosol can or bottle, or from a manually operated pump spray bottle. Although this operation dispenses a proportion of the hairspray onto the hair, it also results in substantial quantities of hairspray fumes being dispersed throughout an area in which spraying is taking place. The generation of these fumes not only represents a wastage of the hairspray composition but it also represents a potential health risk to any person in the vicinity where spraying is taking place.

Typically the spraying operation also results in an uneven application of hairspray onto the hair. Generally, a larger concentration of hairspray is deposited on the outer layers of the hair rather than on the inner layers. Such an uneven distribution of the hairspray may result in reduced and uneven combability, discomfort due to clumping of the hair, and an unbalanced and aesthetically unappealing hairstyle. Manipulation of the hair, such as with a comb, brush or by hand, whilst spraying may result in a more even distribution of hairspray onto the hair. Such a procedure, however, is cumbersome, it requires practice and experience, and it is time consuming.

A further problem associated with the use of spray compositions for styling lies in the location of delivery of the composition. There is a tendency for sprayed styling composition to accumulate on the hair shaft, remote from the roots. However, it is thought that more effective styling, possibly involving the use of less styling composition could be achieved if the styling composition could be more effectively delivered to the hair shaft in the vicinity of the hair roots.

In an attempt to overcome the problems associated with the production of excess fumes from hairsprays, attention has focused on devices including shields to block the fumes or devices including an exhaust system to draw the fumes away from the operator. However, such devices may be relatively cumbersome or expensive and do not address the problems associated with dispensing an uneven application of hairspray onto the hair.

U.S. Pat. No. 4,523,080 discloses a hair dryer in combination with an aerosol spray can for the delivery of hairspray in a stream of hot air.

A spray head for dispensing soluble elastomeric adhesive polymers in a defined fan-shaped spray pattern is described in WO 83/00134. The spray head is adapted for the delivery of small volumes of adhesive.

The present invention seeks to overcome the drawbacks of known apparatus for delivering a hair care composition, in particular a hairspray, onto the hair.

According to a first aspect, the present invention provides a spray head for delivering a hair care composition onto and/or into the hair comprising an inlet in fluid communication with an outlet, the inlet of the spray head being adapted for connection with an outlet of a container containing a hair care composition, the outlet of the spray head including at least one hollow protrusion defining a fluid channel extending from the spray head, the hollow protrusion including at least one opening for delivering the hair care composition onto the hair.

In one embodiment, the spray head of the invention comprises actuating means. The actuating means is preferably manually operable. However, the actuating means may be operable in other ways such as, for example, by contact with the scalp of the user. The actuating means, when operated in use, causes hair care composition to pass from the container to the outlet of the spray head. Optionally, the actuating means may be adapted to allow hair care composition to be delivered not only from the outlet of the spray head but also, alternatively, from one or more other outlets. In this way, the hair care composition can be delivered to the hair from the spray head outlet or from one or more other outlets (eg, conventional aerosol spray outlets), as determined by the user of the spray head. Suitable actuating means are well known to those skilled in the art. Where the actuating means is adapted to allow hair care composition to be delivered not only from the outlet of the spray head but also from one or more other outlets, suitable actuating means may include but are not limited to multi-directional valves, for example two-way rocker action valves or two-way rotational valves. Two-way rocker action valves are well known to the person skilled in the art. By “two-way rotational valve” is meant that the valve is actuated in a first position and rotatable through an angle of between greater than 0° and less than 360°, for example from about 45° to about 225°, preferably about 90°, with respect to the hair care composition container to a second actuating position. Alternatively, the spray head may comprise an outlet of the spray head which is hingeably connected to the remaining portion of the spray head such that movement of the outlet relative to the remaining portion of the spray head allows the hair care composition to be dispensed from another outlet (eg, of the conventional aerosol type); the outlet of the spray head may be hingeably coupled to the remaining portion of the spray head via releasable coupling or may be permanently attached to the remaining portion of the spray head—such an arrangement permits the hair care composition to be delivered conventionally or according to the invention by moving the spray head between first and second positions.

By the term “hair care composition” is meant a composition which provides a styling, a hair-holding, a hair lustering, fibre modifying, and/or a conditioning action. In particular, the hair care composition may be a hairspray including a mixture of agents such as a film-forming resin (e.g. an acrylate copolymer), a copolyol (e.g. dimethicone copolyol), and a cosmetically acceptable carrier (eg a C₁ to C₄ alkyl alcohol and/or water). The hair care composition may further include other ingredients such as a perfume and/or a colouring agent.

The hair care composition received by the inlet of the spray head is preferably delivered as a fluid stream, though in certain less preferred embodiments it may be atomised.

It has been found to be beneficial to atomise the liquid after the container outlet, i.e. it is not necessarily important to have the liquid atomised as it exits the hairspray container. The hollow protrusion having at least one opening may comprise a tube having one or more holes and may be configured so as to cause atomisation of the hair care composition. If the hair care composition is delivered as droplets, it may have a droplet size, preferably an average droplet size, of 1-1000 microns, more conveniently 5-100 microns. The techniques and hardware for generating a fine droplet mist may be generally similar to those used in the generation of conventional spray mists, such as are routinely used on the outlets of conventional hairspray sprayheads or nozzles.

Preferably, the hair care composition is dispensed from a propellant charged aerosol container or a pump action spray container. Most preferably, the hair care composition is dispensed from a pressurised aerosol container. The pressurised aerosol containers may be metered dose or continuous spray aerosol containers.

According to a further aspect of the invention, there is provided an apparatus for delivering a hair care composition onto and/or into the hair comprising a container containing a hair care composition; and a spray head as described above, wherein the inlet of the spray head is connected to and is in fluid communication with an outlet of the container.

The spray head is of simple and lightweight construction. The apparatus for delivering a hair care composition is portable and can be easily moved around the head of a person undergoing hair treatment. This allows the hairspray to penetrate and be evenly dispensed into all layers of the hair, and most importantly to the lower part of the hair shaft in the vicinity of the hair roots, without the need for awkward movements, or for simultaneous manipulation of the hair.

When the apparatus includes a spray head comprising an actuating means adapted to allow hair care composition to be delivered not only from the outlet of the spray head but also from one or more other outlets, the hair care composition may either be delivered to the hair shaft in the vicinity of the roots as described above, or alternatively may be delivered to the hair shaft remote from the roots as in conventional hair spray systems. The method of delivery is determined by the user by depressing or otherwise operating the actuating means in an appropriate manner. Thus, in this embodiment of the invention, delivery of the hair care composition may be achieved either according to the invention or conventionally using the same apparatus.

The inlet of the spray head is dimensioned and adapted for connection with and for establishing fluid communication with the outlet of a spray container including a hair care composition, for example the nozzle and/or the needle valve of a pressurised aerosol container. The outlet may be simply the dip tube of a conventional container or may comprise a dip tube and a suitable attachment such as a nozzle.

The inlet may include connection means, for example an internal screw thread, snap fit arrangement or bayonet fitting, which enables the inlet to be removably connected to the outlet of the hair care container. Alternatively, the inlet may be permanently attached to the outlet of the hair care container for example by gluing or by welding. In yet a further embodiment the inlet of the spray head and the outlet of the hair care container may form a single contiguous structure, being e.g. injection moulded as an integral structure.

It will be appreciated that the inlet of the spray head may be dimensioned for connection with any size outlet of the hair care composition container. The spray head may thus be used with containers of varying shape and size, and may be reusable.

The outlet of the spray head includes at least one hollow protrusion having a first end connected to the spray head and a second preferably sealed end. The hollow protrusion includes at least one opening for delivering the hair care composition into and/or onto the hair. Preferably, the at least one opening is in a side wall in the vicinity of the second end of the hollow protrusion. Preferably, the at least one opening is at an angle which is greater than 0° but less than 180° with respect to the direction of fluid flow along the fluid channel. Preferably, the hollow protrusion includes a plurality of openings which may extend circumferentially around the sidewall and/or longitudinally along the length of the hollow protrusion. More preferably, the spray head includes a plurality of hollow protrusions each of which may include a plurality of openings extending circumferentially around the sidewall and/or longitudinally along the length of the hollow protrusion from the second end to the first end of the protrusion. A preferred number of hollow protrusions on the spray head may be 1-5, for example 2-5, more preferably 1-3, most preferably 1.

In use, the or each hollow protrusion of the spray head is positioned within the hair. Optimally, in use the, or each protrusion is substantially perpendicular to and extends generally away from the scalp of the head. In certain preferred embodiments wherein the sprayhead comprises a plurality of protrusions, the hollow protrusions may extend substantially parallel to each other. The openings of the or each protrusion may point generally upwardly from the scalp through the layers of the hair, or may point (i.e. causing the hair care composition to be dispensed) generally parallel to the scalp.

Actuation of the hair composition container may occur either manually by applying pressure directly to an appropriate part of the container, or alternatively by pressing the end of the, or each hollow protrusion against the scalp which acts to impart pressure on the container and generate atomised hair care composition.

In certain embodiments wherein the spray head further comprises actuating means adapted to allow hair care composition to be delivered not only from the outlet of the spray head but also from one or more other outlets, actuation of the hair composition container may occur manually by applying pressure directly to an appropriate part of the intermediate actuating means.

When the outlet of the hair care composition container is actuated to generate atomised hair care composition, the atomised composition is dispensed laterally from the, or each hollow protrusion through the openings into the hair. This arrangement allows a hair care composition to be delivered more evenly into and onto all parts of the hair without the need for simultaneously manipulating the hair. Further, this arrangement allows the hair care composition to be evenly distributed to the hair shaft, between the scalp and under the surface of the hair style.

Moreover, the lateral dispersion of hairspray from the, or each hollow protrusion results in the hairspray being dispensed within the hair per se, and generally towards the hair shaft in the vicinity of the hair roots, rather than via formation of a cloud of hairspray above the hair which then deposits on the hair. This minimises the amount of excess fumes produced in the vicinity of the spraying operation.

Consequently, it is possible to style the hair by fixing and/or restricting the movement of the hair shaft in the vicinity of the roots rather than by solidifying the outer hair array. This results in a more aesthetically appealing hairstyle having a more natural appearance, with improved sensory properties and improved duration and magnitude of hold.

Alternatively, when the spray head further comprises actuating means adapted to allow hair care composition to be delivered not only from the outlet of the spray head but also from one or more other outlets, actuation of the outlet of the hair care composition container may, if desired, result in the atomised composition being dispensed from the container as in conventional hair spray systems so that the hair care composition is delivered laterally to the hair shaft remote from the roots.

The openings in the, at least one hollow protrusion may be designed so that the hair composition be sprayed at any angle which is greater than 0° but less than 180° with respect to the direction of fluid flow along the fluid channel. In one embodiment the openings may be situated perpendicularly to the direction of fluid flow. Alternatively, the openings may be situated at an angle of greater than 90°, preferably 110 to 170°, more preferably 150°, to the direction of fluid flow.

The openings in the, at least one hollow protrusion are dimensioned to allow a hair care composition to be sprayed laterally from the, or each hollow protrusion. Preferably, the openings have a circular, oval rectangular and/or square cross-sectional shape. Optimally each opening has a circular or oval cross-sectional shape.

Preferably, the openings have a cross-sectional area of between 0.00001 to 0.1 cm², most preferably the openings have a cross-sectional area of 0.0001 to 0.01 cm². Preferably, a spray head according to the invention may have at least three hollow protrusions (more preferably one hollow protrusion), each having preferably from 1 to more than 100 openings, for example between 2 to more than 100 openings, which may be equally circumferentially spaced around each hollow protrusion or otherwise arranged. The openings are preferably located 2 to 80 mm, more preferably 10 to 35 mm, from the second preferably sealed ends of the protrusions.

For the avoidance of doubt, it will be appreciated that when the openings are of a circular cross-section, the openings preferably have a diameter of between 0.001 to 0.4 cm, more preferably from 0.01 to 0.1 cm.

The, or each hollow protrusion is preferably of tubular or conical shape, optimally tubular, more preferably tubular with a rounded tip end. The, or each protrusion may be of variable length, for example from 2 cm to 10 cm in length and of variable cross-sectional area, for example from 0.01 to 0.25 cm², and they may also be of flexible or rigid construction. Most preferably, the, or each hollow protrusion is of a flexible construction. Conveniently, the, or each hollow protrusion may be removably mounted on the spray head. Such an arrangement allows the length of the hollow protrusion(s) to be easily modified so that the spray head can be adapted for use with variable length, thickness and/or different styles of hair.

The spray head may also include a chamber having the inlet and hollow protrusion(s) connected thereto. The chamber may take any cross-sectional shape; preferably it is circular or oval. The chamber may provide an improved fluid path from the inlet to the outlet for the atomised hairspray. Such an arrangement may result in an improved application of hairspray onto and into the hair. In alternative embodiments, the inlet on the spray head may be directly connected to the one or more hollow protrusions, for example via a simple multiple direction tubular connecting piece. Such an embodiment may have the advantage of providing minimal dead space between the spray head inlet and outlet(s).

Alternatively, or additionally, the spray head may include a shield to block and/or exhaust any excess fumes generated in the vicinity of the spraying operation. Preferably, such a shield may be cone shaped and constructed from a transparent material, thereby providing the user with an unrestricted view when applying the hair care composition.

According to a further aspect of the invention, there is provided a method for providing for the delivery of a hair care composition onto and/or into the hair comprising:

providing a container containing a hair care composition;

providing a spray head as described above; and

connecting the inlet of the spray head to the outlet of the container.

According to a further aspect of the invention, there is provided a method of delivering a hair care composition onto and/or into the hair, comprising:

providing a container containing a hair care composition;

providing a spray head as herein described;

positioning the hollow protrusion(s) on the spray head within the hair; and

dispensing the hair care composition from the container.

According to a further aspect, the invention provides use of the apparatus including a spray head and a container containing a hair care composition as described above for delivering a hair care composition onto and/or into the hair.

Preferred embodiments of the invention will now be described by way of example only with reference to the accompanying drawings in which:

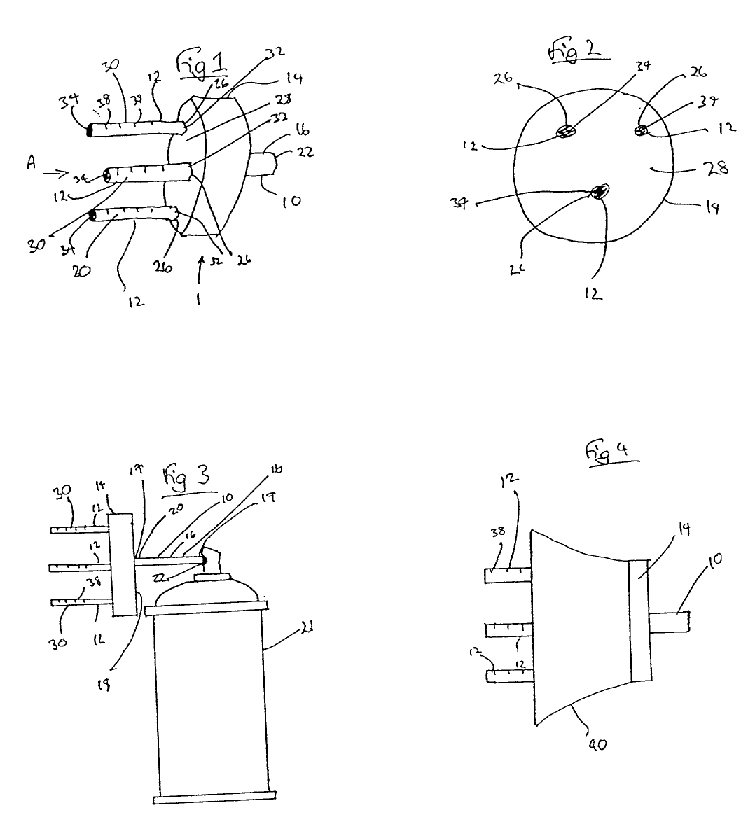

FIG. 1 is a side view of a spray head according to the invention;

FIG. 2 is a view along the line A of the spray head of FIG. 1;

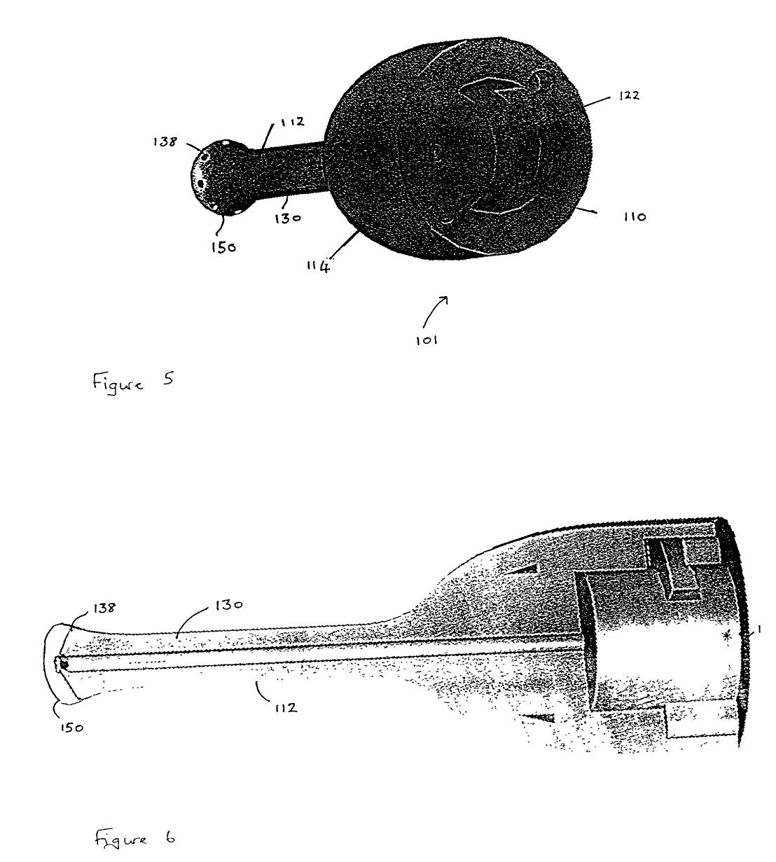

FIG. 3 is a side view of an apparatus including the spray head of FIG. 1.

FIG. 4 is a side view of an alternative preferred spray head.

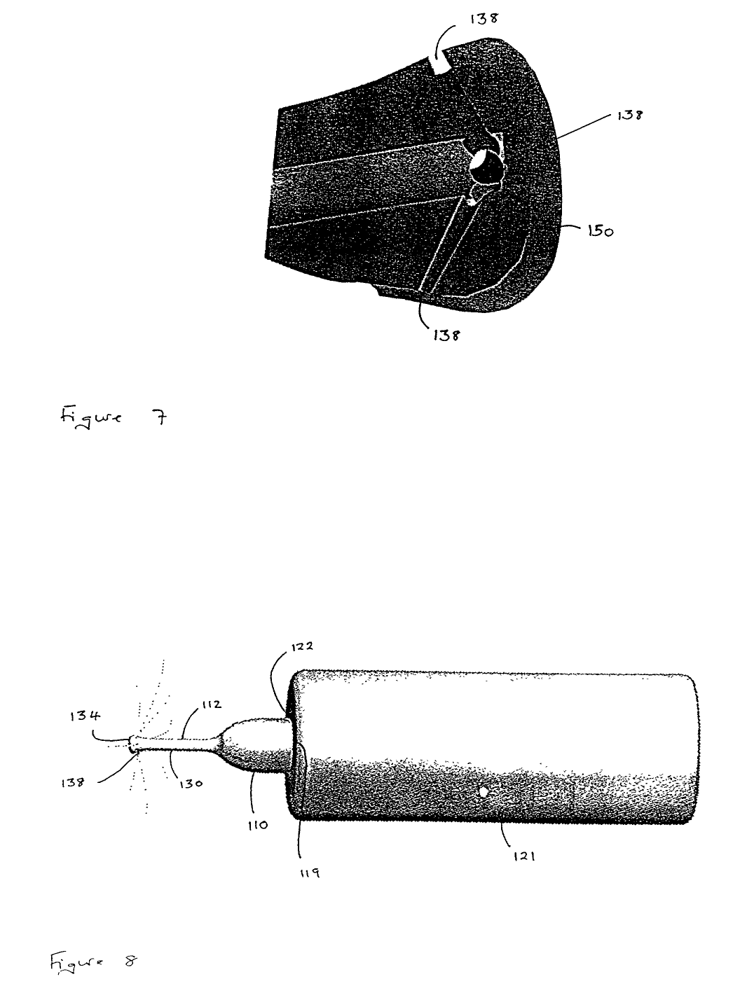

FIG. 5 is a side perspective view of a second alternative of a preferred spray head.

FIG. 6 is a cross-section of the spray head of FIG. 5.

FIG. 7 is an enlarged cross section showing a tip end of the spray head of FIG. 5.

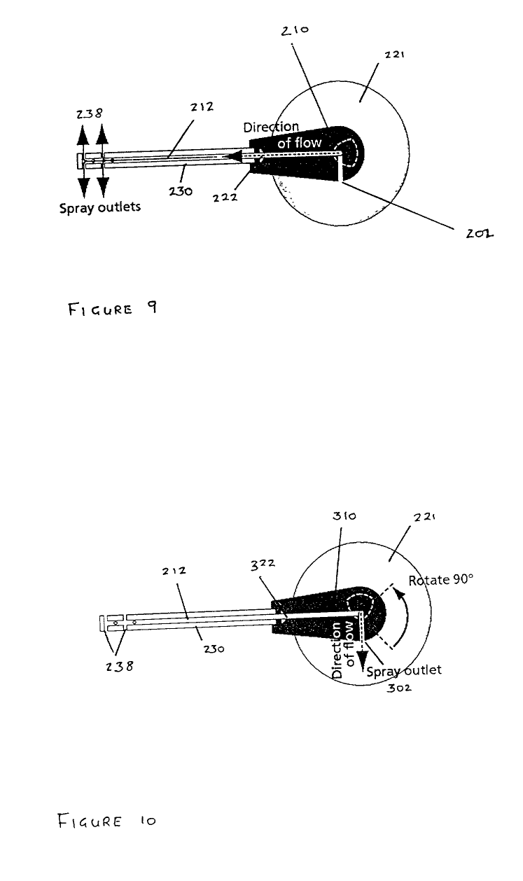

FIG. 8 is a side view of an apparatus including the spray head of FIG. 5.

FIG. 9 is a part-cross-sectional plan view of an alternative apparatus showing a spray head of the invention which comprises a two-way rocker action valve.

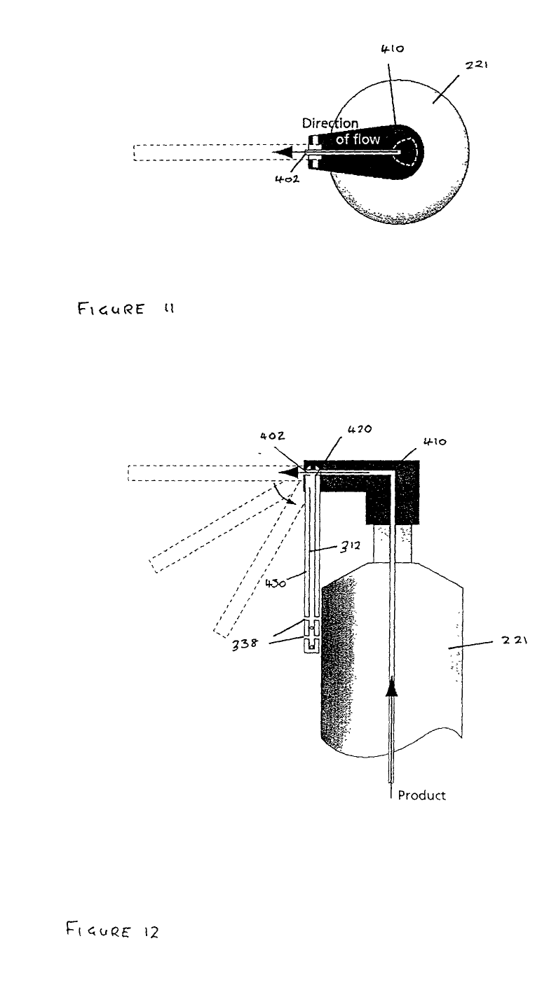

FIG. 10 is a part-cross-sectional plan view of a second alternative apparatus showing a spray head comprising a two-way rotational valve.

FIG. 11 is a part-cross-sectional plan view of a third alternative apparatus showing a spray head of the invention comprising an actuating means hingeably connected to the outlet of the spray head, and

FIG. 12 is a part-cross-sectional side view of the apparatus of FIG. 11 showing the outlet of the spray head positioned parallel to the hair spray composition container.

There is shown in FIGS. 1 and 2, and in FIG. 3 connected to a spray can a spray head 1 for delivering a hair care composition onto and/or into the hair comprising an inlet 10, an outlet 12 and a chamber 14 which together define a fluid channel.

Preferably, the entire spray head is made from plastics materials such as polypropylene, polyethylene terephthalate, polycarbonate, and/or polymethyl methacrylate, by methods known to those skilled in the art, such as injection moulding. The inlet 10, the outlet 12 and the chamber 14 may be formed as a single contiguous structure.

Alternatively, the inlet 10, the outlet 12 and the chamber 14 may be formed as separate structures which may be assembled into the spray head 1.

The inlet 10 includes a hollow protrusion 16 which extends from a first side wall of the chamber 14. Preferably, the hollow protrusion 16 is a tubular or conical shaped structure. The hollow protrusion 16 includes a first end 20 which is connected to an orifice 17 in the first side 18 of the chamber 14 and a second open end 22 for connection to an outlet 19 of a container 21 containing a hair care composition, for example a pressurised aerosol hairspray as shown in FIG. 3.

The inlet 10 may be removably mounted to the chamber 14, for example by connecting the first end of the inlet 20 to a nipple (not shown) extending from the first side wall 18 of the chamber 14. The nipple is preferably conical shaped, and includes a ribbed outer wall to grip the inner wall of the inlet 10 adjacent first end 20. The nipple has a fluid channel extending therethrough. The second open end 22 of the inlet 10 is in fluid communication with the interior of the chamber 14 via hollow protrusion 16.

Alternatively, the inlet 10 may be permanently mounted to the chamber 14.

The second open end 22 of the inlet is adapted for connection to the outlet 19, for example a nozzle, of a pressurised aerosol container 21.

The second end 22 of the inlet may include a screw thread on its inner or outer wall for engagement with a complimentary screw thread on the nozzle of the pressurised aerosol container 21. Alternatively, the second end 22 of the inlet may be adapted for snap fit engagement with the nozzle of the hair care composition container 21, optionally releasable snap fit engagement, or may be adapted to accommodate one element of a bayonet fitting for engagement with a complementary element of the bayonet fitting on the nozzle of the hair care composition container 21. Such methods will be well known to those skilled in the art. In use, the second end 22 of the inlet 10 may be either removably or permanently connected to the outlet 19 of the pressurised aerosol container 21.

The chamber 14 is a hollow chamber having an orifice 17 in the first side wall 18 for establishing fluid communication with the inlet 10 and a plurality of orifices 26 in the second side wall 28 for establishing fluid communication with the outlets 12. Preferably, the chamber 14 is cylindrical in shape.

The outlets 12 comprise a plurality of hollow protrusions 30 extending from the second side wall 28 of the chamber 14. The hollow protrusions 30 are tubular, and include first open ends 32 which are connected to the orifices 26 of the chamber 14 and second sealed ends 34, which may be rounded to minimise any scalp abrasion in use. The hollow protrusions 30 define a fluid channel which is in fluid communication with the interior of the chamber 14 and the inlet 10.

The hollow protrusions 30 may be mounted to the chamber 14 by similar means as for mounting the inlet 10, for example by connecting the first open end of the hollow protrusion 30 to a ribbed nipple (not shown) having a fluid channel extending therethrough. The hollow protrusions 30 may be either removably or permanently mounted to the chamber 14, and may be integrally moulded therewith.

The second end 34 of the hollow protrusion is sealed by methods well known to those skilled in the art, for example by heat sealing.

In the region of the second sealed end 34 of each hollow protrusion 30 are a series of circular openings 38. The openings 38 extend circumferentially around the hollow protrusion and longitudinally along the length of the hollow protrusion 30 from the second sealed end 34 to the first open end 32. The openings 38 define a cross-sectional area of between 0.05 to 0.1 cm² and are of circular cross-section. The openings 38 are formed in the hollow protrusions 30 by methods well known to those skilled in the art, for example by automated piercing machinery.

The openings 38 on hollow protrusions 30 may be configured to effect any desired spray pattern. For example, as shown in FIG. 2, the hollow protrusions 30 form an equilateral triangle configuration as chamber 14. The openings 38 on hollow protrusions 30 in this embodiment may conveniently be located in two lines on each hollow protrusion, each line of openings 38 running longitudinally along each hollow protrusion 30, with the lines being on opposite sides of each hollow protrusion, with one line on each hollow protrusion 30 generally facing towards the centre of the equilateral triangle formed by the hollow protrusions 30. Other configurations of openings 38 are however envisaged, such as for example more than two longitudinal lines of openings 38 on each hollow protrusion, the lines of openings 38 facing other directions to form desired spray coverage patterns, or one or more spiral configurations of openings 38 on each hollow protrusion 30.

An alternative embodiment of the spray head 1 is shown in FIG. 4. The chamber 14 has attached thereto a cone 40 extending therefrom in the direction of the outlet 12, which acts in use as a shield. The cone 40 partially covers the hollow protrusions 30. In use, the cone 40 contains any excess fumes of hairspray and thus substantially reduces any deleterious effects such fumes may have to persons in the vicinity where spraying is taking place.

There is shown in FIGS. 5 to 7 a second alternative embodiment of the spray head 101. In this embodiment the inlet 110, outlet 112 and chamber 114 form a single contiguous structure and result in a single hollow protrusion 130 which terminates in a tip end 150. Preferably, the entire spray head 101 is made from suitable plastics materials as described hereinbefore.

The open end 122 of the inlet is adapted for connection to an outlet of a container, for example a nozzle of a composition container 121 shown in FIG. 8. In this embodiment the open end 122 includes a female bayonet fitting on its inner wall adapted for engagement with a complementary male bayonet fitting on the nozzle of the container 121 (not shown). However, a screw thread or snap fit arrangement would be equally suitable.

The outlet 112 forms a single hollow protrusion 130 which is tubular in shape and may be rounded at the tip end 150 to minimise any scalp abrasion in use. Alternatively, padding may be added to the tip end to increase comfort for the user. The tip end 150 may also enable actuation of the hair spray container in use by depressing the end of the tip against the scalp in order to impart pressure to the nozzle of the container 121 thereby releasing hair composition contained therein.

In this embodiment the openings 138 are positioned at an angle of approximately 150° with respect to the direction of fluid flow along the fluid channel in the hollow protrusion so that, in use, the hair composition is sprayed laterally into/onto the hair. However, openings with angles of greater than 0° but less than 180° with respect to the direction of fluid flow along the fluid channel would be equally suitable. Multiple openings 138 positioned at different angles are also contemplated. The openings 138 extend circumferentially around the hollow protrusion in the region of the tip end 150 but may also extend longitudinally along the length of the hollow protrusion 130 from the tip end to the open end 122. The shape, dimensions, configuration and methods of preparation of the openings 138 are the same as those outlined in respect of spray head 1 shown in FIGS. 1 to 4.

FIG. 7 shows a close up sectional view of the tip end 150 of the spray head 101 of FIG. 5. The hollow protrusion 130 contains a multiplicity of angular openings 138 which extend circumferentially around the sidewall.

In use, as shown in FIG. 3, the second open end 22 of the inlet 10 is connected to the outlet 19 of a container 21 including the hair care composition. The outlets 12 of the spray head 1 are positioned in the hair. Optimally, the second, sealed end 34 of the outlet is adjacent to the scalp of the head and the hollow protrusions extend ideally generally perpendicular from the scalp and through the hair. The openings 38 of the hollow protrusions 30 are spaced in between the layers of hair.

Actuation of the outlet 19 of the haircare container 21 results in a fine hairspray being dispensed laterally from the hollow protrusions 30 through the openings 38. This results in an even application of hairspray to all layers of the hair without the need for simultaneously manipulating the hair during spraying. The lateral dispersion of hairspray from the outlets 38 results in the hairspray being dispensed within the hair per se rather than via formation of a cloud of spray above the hair which later deposits on the hair. This results in improved deposition of the hairspray to the hair shaft in the vicinity of the hair roots rather than the outer hair shaft, and it minimises the amount of excess fumes produced in the vicinity of the spraying operation.

In an alternative envisaged embodiment (not shown), the inlet 10 may be linked directly to each of the outlets 12 by a simple tube, which tubes converge in an appropriate multi-entrance joint which is in fluid communication with inlet 10.

FIG. 9 shows a plan view of an apparatus of the invention incorporating a spray head of the invention comprising a two-way rocker action valve 210 attached via the inlet of the spray head to an outlet (not shown) of a hair care composition container 221. The two-way rocker action valve enables the user to direct the fluid flow from the container 221 via either a conventional hair spray valve outlet 202 or via perpendicular outlet 222 along the fluid channel 212 to one or more angular openings 238 at the end of the hollow protrusion 230. In use, actuation of the apparatus to direct fluid flow from the hair care composition container 221 to the desired outlet 202 or 222 occurs by depressing the appropriate side of the two-way rocker action valve remote from the said outlet.

FIG. 10 shows a plan view of an apparatus of the invention showing a spray head of the invention comprising a two-way rotational valve 310. The rotational valve has outlets 302 and 322 positioned at an angle greater than 0° and less than 360° relative to each other. In FIG. 10 the rotational valve outlets 302 and 322 are shown positioned at 90° to each other. In use, the user is able to direct fluid flow through either of the outlets, as desired, by rotating the valve head through an angle, in this case 90°, in order to align the valve outlet appropriately. Fluid exits either through valve outlet 302 directly to the hair shaft remote from the roots as in conventional hair sprays, or via valve outlet 322 along the fluid channel 212 of the hollow protrusion 230 through apertures 238 when it is desired that the hair spray is directed to the hair shaft in the vicinity of the roots.

FIG. 11 shows a plan view of an alternative apparatus of the invention wherein the actuating means is an alternative hair spray nozzle 410 which has been adapted to hingeably connect with the outlet of the spray head of the invention so that the hollow protrusion 430 (shown in hatched lines) may be positioned at an angle of between 0° and 90° with respect to the direction of fluid flow from the alternative hair spray valve outlet 402 as shown. This enables the hollow protrusion 430 of the spray head to be aligned with the outlet 402 of the alternative hair spray nozzle allowing fluid to flow from the outlet of the container 221 via the inlet of the spray head along the fluid channel 312 to the openings 338 when it is desired to direct hairspray to the hair shaft in the vicinity of the roots of the hair. If the user wishes to direct hairspray to the surface of the hair as in a conventional hair spray container, the hollow protrusion 430 is hingeably rotated about the axis 420, preferably to a position where it is aligned parallel to the longitudinal axis of the container 221 so that it does not interfere with the emission of hairspray from outlet 402 as shown in FIG. 12. Actuation of the container to release atomised hair care composition occurs by depressing the appropriate part of the actuating means 410.

1. A spray head for delivering a hair care composition onto and/or into the hair comprising an inlet in fluid communication with an outlet, the inlet of the spray head being adapted for connection with an outlet of a container for containing a hair care composition, the outlet of the spray head including at least one hollow protrusion defining a fluid channel extending from the spray head, the hollow protrusion including an opening for delivering the atomised hair care composition onto the hair.

2. A spray head as claimed in claim 1 wherein the at least one hollow protrusion includes a first end connected to the spray head and a second sealed end.

3. A spray head as claimed in claim 1 or 2 wherein the opening of the at least one hollow protrusion is in the region of the second end.

4. A spray head as claimed in claim 3 wherein the at least one opening is in the side wall of the hollow protrusion.

5. A spray head as claimed claim 3 wherein the at least one opening is at an angle which is greater than 0° but less than 180° with respect to the direction of fluid flow along the fluid channel.

6. A spray head as claimed in any one of the preceding claims wherein the at least one hollow protrusion includes a plurality of openings.

7. A spray head as claimed in any one of the preceding claims wherein the spray head includes a plurality of hollow protrusions.

8. A spray head as claimed in any one of the preceding claims further including a chamber, wherein the inlet and outlet of the spray head are in fluid communication with the chamber.

9. A spray head as claimed in claim 8 wherein the first said end of the hollow protrusion is connected to the chamber.

10. A spray head as claimed in any one of claims 6 to 9 wherein the hollow protrusion extends from the chamber.

11. A spray head as claimed in any of the preceding claims further comprising an actuating means permitting fluid communication between the inlet of the spray head and the outlet of the spray head or one or more other outlets.

12. A spray head as claimed in claim 11 wherein the actuating means is selected from a two-way rocker action valve or a two-way rotational valve.

13. A spray head according to claim 11 wherein the actuating means is hingeably connected to the outlet of the spray head.

14. A spray head as claimed in any one of the preceding claims wherein the hollow protrusion is removably mounted to the spray head.

15. A spray head as claimed in any one of the preceding claims wherein the hollow protrusion is tubular or conical shaped.

16. A spray head as claimed in any one of the preceding claims further including a shield.

17. A spray head as claimed in any one of the preceding claims wherein the opening of the hollow protrusion has a cross-sectional area of 0.00001 to 0.1 cm².

18. Apparatus for delivering a hair care composition onto and/or into the hair comprising:
a container including a hair care composition; and
a spray head as defined in any one of the preceding claims wherein the inlet of the spray head is connected to and is in fluid communication with an outlet of the container.

19. Apparatus as claimed in claim 18 wherein the spray head is removably connected to the container.

20. An apparatus as claimed in claim 18 or claim 19 wherein the apparatus is actuated by pressing the end of the, or each, hollow protrusion against the scalp.

21. An apparatus as claimed in any one of claims 18 and 19 which is adapted to be actuated by manually applying pressure directly to an appropriate part of the actuating means.

22. Use of a spray head as claimed in any one of claims 1 to 17 for delivering a hair care composition onto and/or into the hair.

23. Use of the apparatus as claimed in any one of claims 18 to 21 for delivering a hair care composition onto and/or into the hair.

24. A method of providing for the delivery of a hair care composition onto and/or into the hair comprising:
providing a container including a hair care composition;
providing a spray head as defined in any one of claims 1 to 17;
connecting the inlet of the spray head to the outlet of the container.

25. A method of delivering a hair care composition onto and/or into the hair comprising:
providing a spray head as described in any of claims 1-17;
positioning the hollow protrusion on the spray head within the hair; and
dispensing the hair care composition from the container.

26. An apparatus for delivering a hair care composition onto and/or into the hair substantially as described and/or depicted herein with reference to the description and accompanying drawings.

27. A method for delivering a hair care composition onto and/or into the hair substantially as described and/or depicted herein with reference to the description and accompanying drawings.
